(19) United States
(12) Patent Application Publication
(10) Pub. No.: US 2003/0012371 A1
(43) Pub. Date: Jan. 16, 2003

(54) Phone sock

(76) Inventors: Ed Weinstock, Port Washington, NY (US); Vincent Smith, Bexley, OH (US)

Correspondence Address: Michael I. Kroll, 171 Stillwell Lane, Syosset, NY, 11791, US

(21) Appl. No.: 09/900,907

(22) Filed: Jul. 9, 2001

(51) Int. Cl. H04M 1/00

(52) U.S. Cl. 379/452

(57) ABSTRACT

The present invention 10 discloses a hygienic telephone receiver 18, cover 10 which comprises a germicidal screen cover 24, 26 for the ear piece and mouth piece of the telephone receiver 18. The covers 24, 26 are impregnated with a germicidal composition designed to destroy bacteria and other germicidal agents and prevent the user from becoming infected. A receiver cover 10 comprises a center elliptical opening 20 on its back 22 wherethrough the first end of a telephone is inserted and the cover 10 can then be stretched over the telephone until the second end of the telephone receiver 18 is inserted therein. A slit 28 is provided in the cover 10 for receiving the cord 30 of the telephone. Alternative embodiments equip the cover 10 with either drawstrings 38 or elastic bands 40 which connect the cover to the receiver 18. Further, the present invention can be made in both a round shape or a rectangular shape 44 in various sizes to fit both public, cell and cordless telephones and office phones.

### BACKGROUND OF THE INVENTION

1. Field of the Invention

The present invention relates generally to hygienic telephone covers and more particularly to sanitary disposable, biodegradable telephone covers. The disposable biodegradable telephone receiver cover of the present invention consists of an ear and mouth screen impregnated throughout with a germicidal composition. This is provided to protect from various diseases that may be communicated due to germs in the telephone mouthpiece and earpiece as well as the handle. The screen itself is of a loose knit material and does not impede sound incoming or outgoing. The receiver cover also consists of a center elliptical opening in the back portion which permits a receiver to be inserted therein. Once one end is inserted into the biodegradable material, it may then be stretched over the other end of the receiver until the cover is in place. The cover device of the present invention may be used on any and all public, cell, and cordless telephone receivers of various shapes and sizes to provide protection to the public using such phones. When use of the cover is complete, the user can remove and dispose of it in the trash. It is desirable to provide a disposable, simple, inexpensive biodegradable phone cover that will provide adequate protection and not interfere with clear voice transmission and reception. In addition to the above, also disclosed are single mouth piece and ear piece covers that are applied to the mouth and ear piece of a telephone receiver. These also comprise germicidal screens and are slipped over the mouth and earpiece and fastened by drawstrings or elastic bands.

2. Description of the Prior Art

There are other phone receiver cover devices designed for covering phone receivers Typical of these is U.S. Pat. No. 4,736,418 issued to Steadman on Apr. 5, 1988.

Another patent was issued to Colella on Apr. 4, 1989 as U.S. Pat. No. 4,819,265.

Yet another U.S. Pat. No. 4,964,161 was issued to Trowbridge on Oct. 16, 1990 and still yet another was issued on Apr. 30, 1991 to Dale et al. as U.S. Pat. No. 5,012,513.

Another patent was issued to Provence et al on Mar. 26, 1996 as U.S. Pat. No. 5,501,329. Yet another U.S. Pat. No. 5,930,356 was issued to Harrison on Jul. 27, 1999.

### U.S. Pat. No. 4,736,418

### Inventor: Diana M. Steadman

### Issued: Apr. 5, 1988

A removable, washable cover for a telephone handset comprises an outer fabric cover, suitably cotton, and an inner cushioning layer also preferably cotton having a cavity for receiving a telephone handset. An elongated opening is provided along the rear or front panels of the cover and cushioning layer. The edges of the cover along the opening are provided with cooperative fastening materials such as two strips of VELCRO.

### U.S. Pat. No. 4,819,265

### Inventor: James A. Colella

### Issued: Apr. 4, 1989

A telephone handset cover that is disposable and impregnated throughout with a germicidal composition. The handset cover has a top center slit in its back portion which permits a handset to be inserted therein. After the handset is contained within the cover, a tab that extends across the top center slit will close the slit. On the inside of the cover next to the inside adhesive surface of the tab is a second adhesive surface. This second adhesive surface connects and fixes the cover to the handset.

### U.S. Pat. No. 4,964,161

### Inventor: Allen R. Trowbridge

### Issued: Oct. 16, 1990

A cover for a telephone handset includes a monolithic, one-piece body that has speaker-covering and earpiece-covering holes defined therein, and a speaker filter element and an earpiece filter element removably mounted on the body in covering relationship with each of the holes. The filter elements are removed and replaced after each use of the cover so that germs on one handset will not be transmitted to the speaker or earpiece of another handset by the cover.

### U.S. Pat. No. 5,012,513

### Inventor: George L. Dale

### Issued: Apr. 30, 1991

A telephone handset cover 10 for covering a conventional telephone handset 1, typically of the type employed in public telephone facilities. Handset cover 10 is installed upon handset 1 with or without shank 16. Shank 16 may be a single piece or a plurality of pieces. Where employed, shank 16 may be separate from cover 10 or integrally molded there into, and serves to hold handset 1 together continuous function even in the event of breakage of handset 1. In general handset cover 10, and shank 16 function to absorb or deflect impact energy directed at handset 1 to prevent damage to, or contain the damage done to, telephone handsets in public telephone facilities. Handset cover 10 is typically non-removable by the user, in that it is installed either with temporary epoxy glue strips 15 or with angled metal closure shanks 26. Handset cover 10 may be closed either along the back of handset 1 or along the cradle side of handset 1.

### U.S. Pat. No. 5,501,329

### Inventor: Daniel J. Provence

### Issued: Mar. 26, 1996

A cover for enclosing the communicating portions of a telephone handset. The inventive device includes a cover assembly positionable into an abutting relationship with the mouthpiece or earpiece of a handset. An engaging assembly extends from the cover assembly for circumferentially extending about the mouthpiece or earpiece and engaging a groove extending about the handset.

### U.S. Pat. No. 5,930,356

### Inventor: Mark R. Harrison

### Issued: Jul. 27, 1999

A telephone handset cover configured to closely and substantially cover a telephone handset and having an opening extending the length of one side for insertion of the handset. The handset cover is used to protect individuals from germs or other hazards associated with the use of public telephones. The handset cover is made of molded plastic material and has apertures in the mouthpiece and earpiece to facilitate normal use of the telephone handset. The opening along the one side allows a user to insert the telephone handset into the cover while the handset hangs on a telephone hook, which provides full coverage of the mouthpiece and earpiece surfaces that lie in closest proximity to the head of the user and prevents contact with the handset.

While these phone receiver covers may be suitable for the purposes for which they were designed, they would not be as suitable for the purposes of the present invention, as hereinafter described. It is there for desirable to provide a disposable, simple, inexpensive sanitary, biodegradable telephone phone cover that will provide adequate protection and not interfere with clear voice transmission and reception, and protect the public from communicating germs.

### SUMMARY OF THE PRESENT INVENTION

The present invention discloses a hygienic telephone receiver cover which comprises a germicidal screen cover for the earpiece and mouthpiece of the telephone receiver. The covers are impregnated with a germicidal composition designed to destroy bacteria and other germicidal agents and prevent the user from becoming infected. A receiver cover comprises a center elliptical opening on its back wherethrough the first end of a telephone is inserted and the cover can then be stretched over the telephone until the second end of the telephone receiver is inserted therein. A slit is provided in the cover for receiving the cord of the telephone. Alternative embodiments equip the cover with either drawstrings or elastic bands which connect the cover to the receiver. Further, the present invention can be made in both a round shape or a rectangular shape in various sizes to fit both public, cell, and cordless office telephones.

A primary object of the present invention is to provide a protective cover for telephone receivers.

Another object of the present invention is to provide germicidal screens for the mouth and ear portions of the cover.

Yet another object of the present invention is to provide a simple, inexpensive, biodegradable and disposable telephone receiver cover.

Still yet another object of the present invention is to provide a telephone receiver cover that minimizes the communication of germs from phones shared by more than one person.

Yet another object of the present invention is to provide a disposable, biodegradable phone receiver cover that is easily attached to a phone receiver and is provided to fit various size and shape phone receivers.

Still yet another object of the present invention is to provide individual mouth and ear piece cover that may be fastened to the receiver mouth and earpiece by means of a drawstring or elastic band.

Additional objects of the present invention will appear as the description proceeds.

The present invention overcomes the shortcomings of the prior art by providing a germicidal screens for the mouth and ear portions of the cover. Another object of the present invention is to provide germicidal screens for the mouth and ear portions of the cover. Yet another object of the present invention is to provide a simple, inexpensive, biodegradable and disposable telephone receiver cover. Still yet another object of the present invention is to provide a telephone receiver cover that minimizes the communication of germs from phones shared by more than one person. Yet another object of the present invention is to provide a biodegradable disposable phone receiver cover that is easily attached to a phone receiver.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is a pictorial illustration of the device of the present invention in use.

FIG. 2 is a perspective view of the device of the present invention showing a telephone receiver about to be inserted into the sanitary disposable, biodegradable telephone cover through an entry port located on the rear portion of the cover.

FIG. 3 is a perspective view of the present invention showing the telephone receiver being inserted into the cover of the present invention.

FIG. 4 is a perspective view of the cover of the present invention mounted or attached to a telephone receiver.

FIG. 5 is a rear view of the cover of the present invention showing an elliptical opening for insertion of a phone receiver. Also shown, a slit to allow the cord of the receiver to be inserted.

FIG. 6 is sectional view of the cover of the present invention.

FIG. 7 is a perspective view of the present invention, showing a telephone receiver inserted into the cover of the present invention.

FIG. 8 is a pictorial illustration depicting possible dispensaries for disposable telephone receiver covers of the present invention. One dispenser for personal use and one for public dispensaries.

FIG. 9 is a pictorial illustration depicting individual mouth and earpiece covers for a telephone receiver. A drawstring insures a snug fit to the receiver. The device of the present invention is provided in various size and shape to accommodate various type phones.

FIG. 10 is a pictorial illustration depicting individual mouth and earpiece covers for a telephone receiver. An elastic band insures a snug fit to the receiver.

### LIST OF REFERENCE NUMERALS

With regard to reference numerals used, the following numbering is used throughout the drawings.

| | |
|---|---|
| 10 | present invention |
| 12 | user |
| 14 | personal dispenser |
| 16 | public dispenser |
| 18 | receiver |
| 20 | insertion hole |
| 22 | rear of cover |
| 24 | germicidal screen |
| 26 | germicidal screen |
| 28 | opening for telephone cord |
| 30 | cord of telephone |
| 32 | coin dispenser |
| 34 | mouth piece cover |
| 36 | ear piece cover |
| 38 | draw string |
| 40 | elastic band |
| 42 | round shape |
| 44 | rectangular shape |

### DESCRIPTION OF THE PREFERRED EMBODIMENT(S)

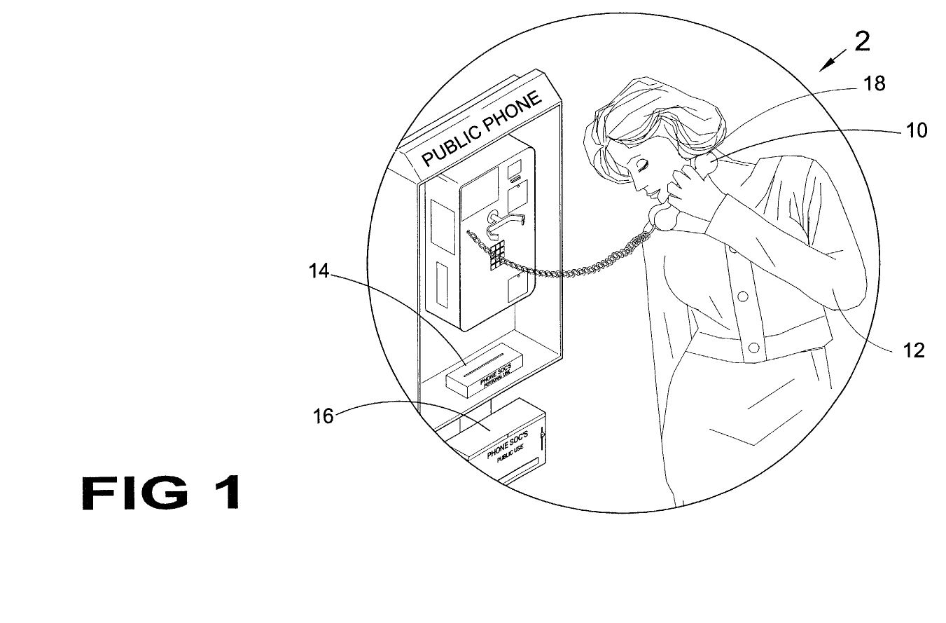

In order that the invention may be more fully understood, it will now be described, by way of example, with reference to the accompanying drawings in which FIGS. 1 through 10 illustrate the present invention being a telephone receiver hygienic cover.

Turning to FIG. 1, shown therein is a pictorial illustration of the device of the present invention 10 in use by a user 12. Also shown is a personal dispenser 14 along with a public dispenser 16 of multiple units of the present invention 10. The present invention 10 comprises a sanitary disposable, biodegradable telephone receiver hygienic cover or sock which comprises an ear piece cover and a mouth piece impregnated with a germicide composition to prevent the user from contacting germs from the telephone receiver 18. When one end of the receiver 18 is inserted into the cover 10, the sanitary disposable, biodegradable telephone cover is then stretched over the other end of the receiver until insertion is complete.

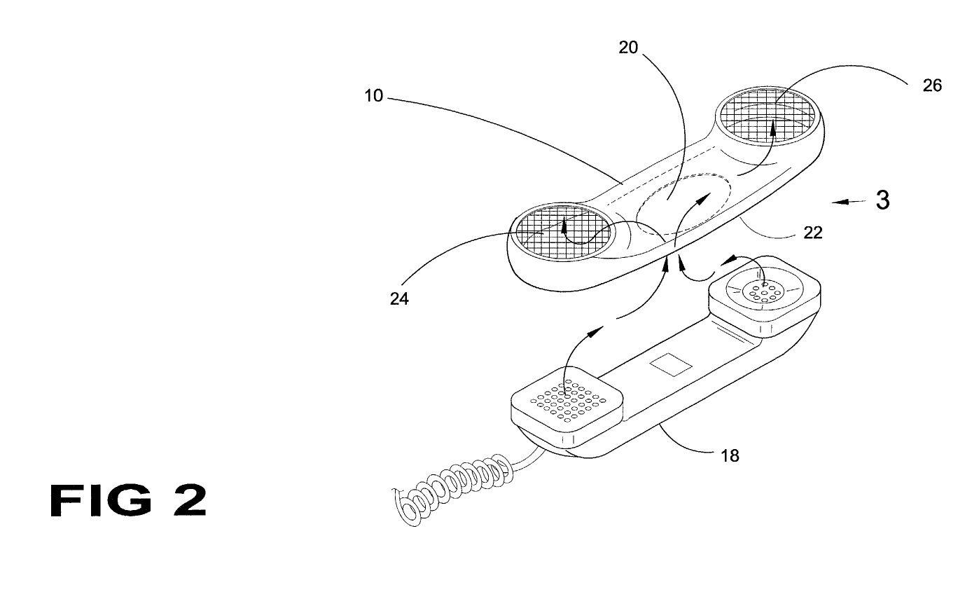

Turning to FIG. 2, shown therein is a perspective view of the device of the present invention 10 showing a telephone receiver 18 about to be inserted into the sanitary disposable, biodegradable telephone cover 10 through an entry port or phone insertion hole 20 located on the rear portion 22 of the cover 10. Also shown is a first germicidal barrier screen 24 on the receiving end of a telephone receiver 18 and a second germicidal barrier screen 26 on the ear piece end of a telephone receiver 18. One end of receiver 18 is inserted into the sanitary disposable, biodegradable telephone cover 10 through entry port 20 located on the rear portion 22 of the cover 10 and the cover is then stretched over the other end of the receiver until insertion is complete.

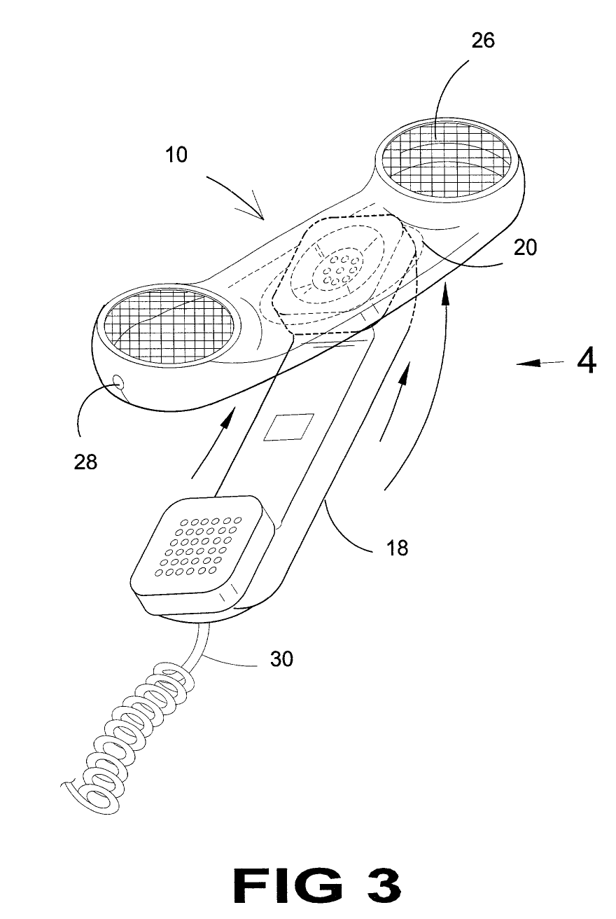

Turning to FIG. 3, shown therein is a perspective view of the present invention 10 showing the telephone receiver 18 being inserted into the cover 10 of the present invention. Shown is a first end of the receiver 18 being inserted through the cover insertion hole 20 whereby the sanitary disposable, biodegradable telephone cover can then be stretched over the other end of the telephone receiver 18 until insertion is complete. Also shown is a cord access opening or slit 28 provided in the cover 10 for receiving a telephone cord 30.

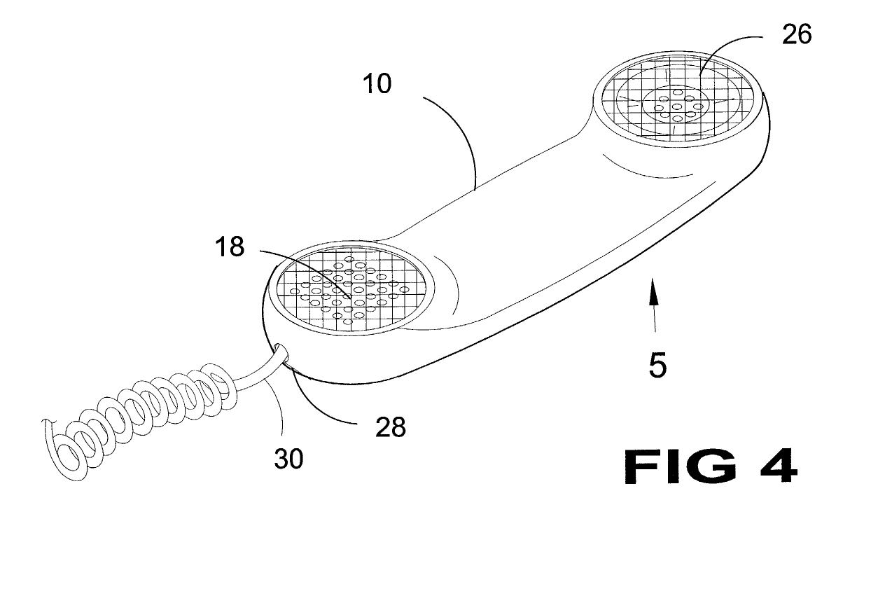

Turning to FIG. 4, shown therein is a perspective view of the cover 10 of the present invention mounted or attached to a telephone receiver 18. Shown therein is the telephone receiver 18 inserted into the sanitary disposable, biodegradable telephone cover 10 of the present invention showing the cord access opening 28 receiving the cord 30 of the telephone. Other elements previously disclosed are also shown

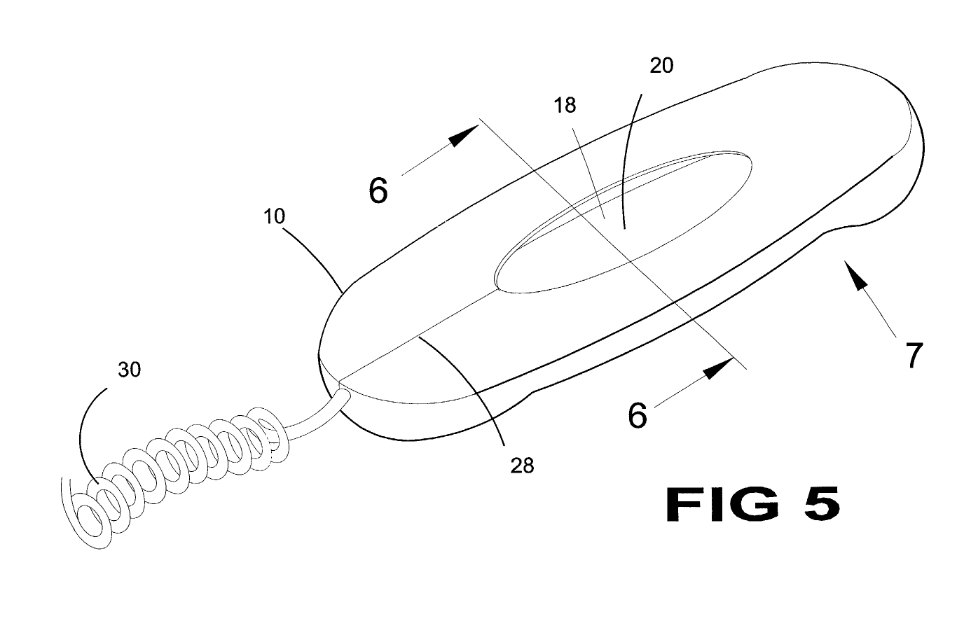

Turning to FIG. 5, shown therein is a rear view of the cover 10 of the present invention showing an elliptical opening 20 for insertion of a phone receiver. Also shown is a slit 28 to allow the cord 30 of the receiver 18 to be inserted. Shown is a telephone handset 18 enclosed in the present invention 10. The sock 10 has a centrally disposed aperture 20 and a slit 28 whereby the handset can be inserted therein.

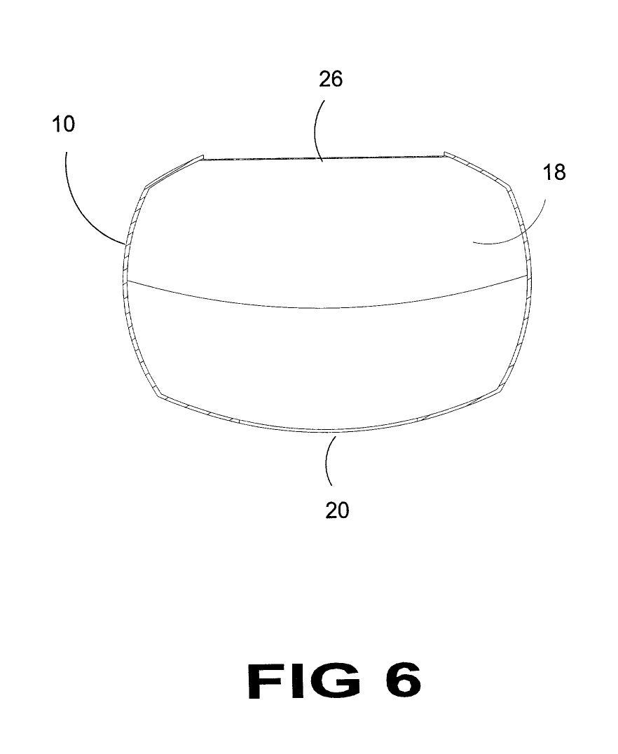

Turning to FIG. 6, shown therein is sectional view of the cover 10 of the present invention. Shown is the telephone hand set receiver 18 from an end view. The hand set cover 10 is made of elastomeric material which will substantially conform to the shape of the hand set. Also shown is the germicidal barrier 26 which will aid the user by killing some or all of the pre-existing bacteria which might be on the hand set 18 along with insertion hole 20.

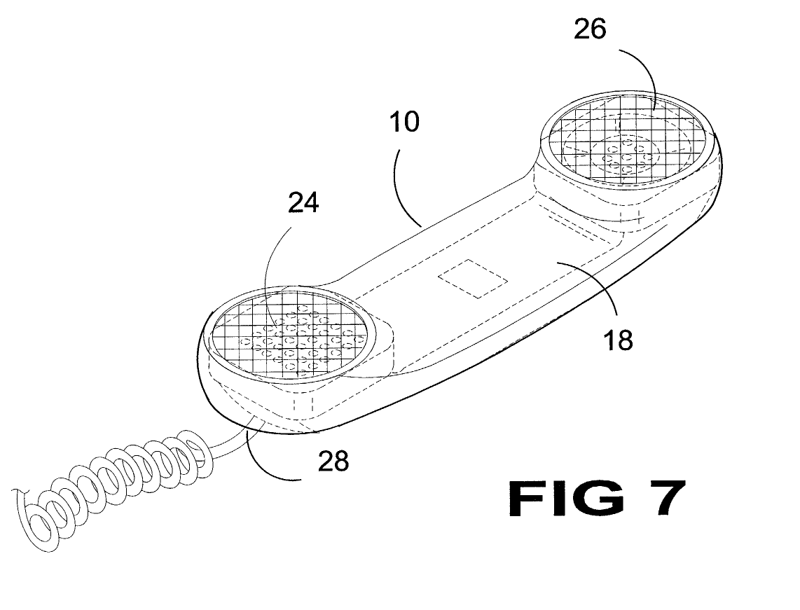

Turning to FIG. 7, shown therein is a perspective view of the present invention 10, showing a telephone receiver 18 inserted into the cover 10 of the present invention. Shown is the telephone receiver inserted into the cover 10 showing a germicidal barrier 24 over the mouthpiece of the phone and a germicidal barrier 26 over the earpiece of the telephone receiver 18.

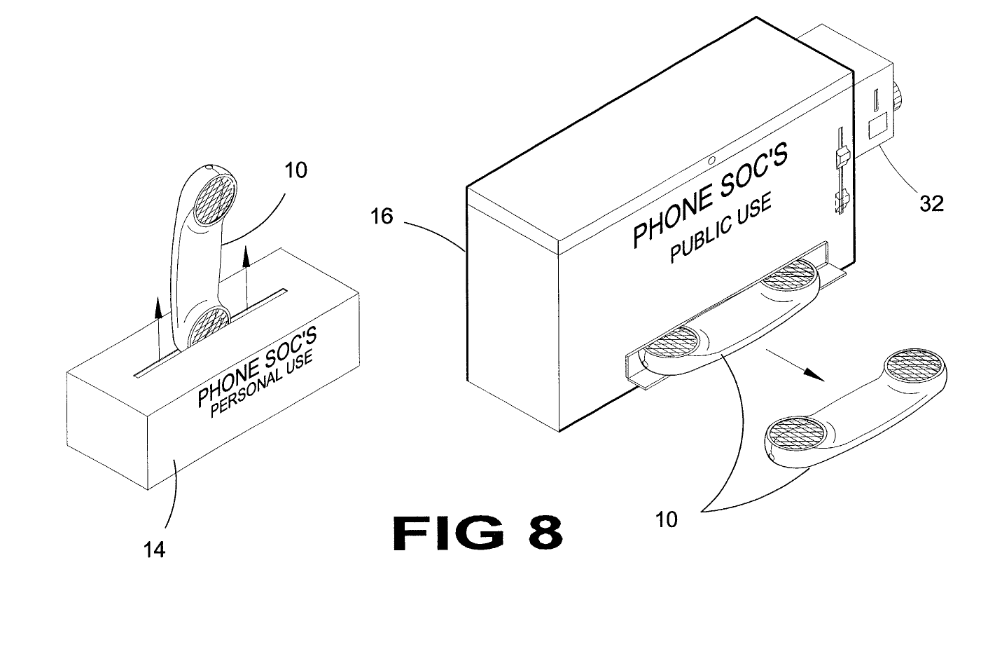

Turning to FIG. 8, shown therein is a pictorial illustration depicting possible dispensaries for disposable telephone receiver covers 10 of the present invention. One dispenser would be for personal use 14 and one for public dispensaries 16. A coin dispenser 32 is also shown on the public dispenser 16.

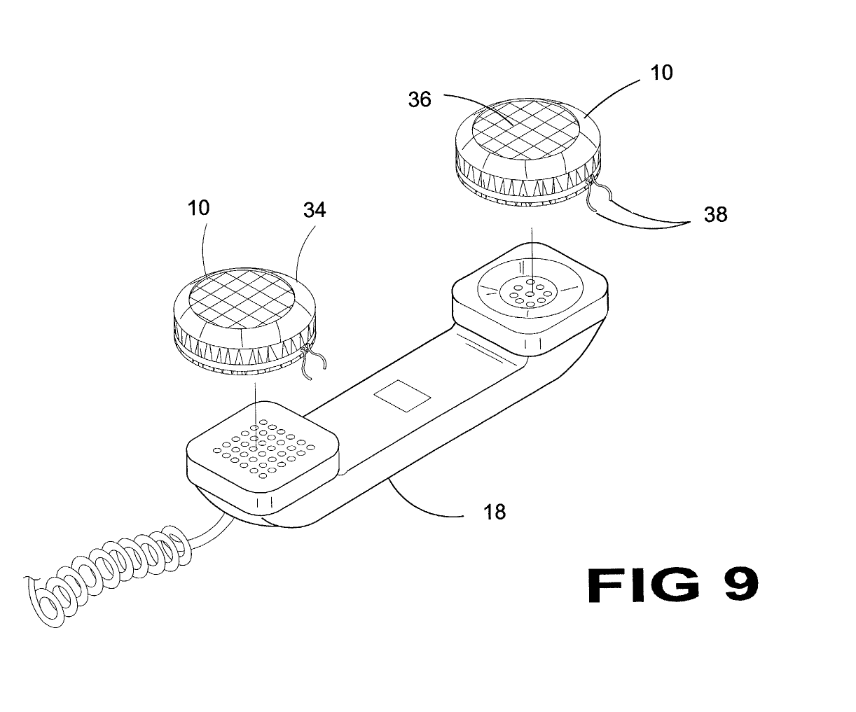

Turning to FIG. 9, shown therein is a pictorial illustration depicting individual mouth and earpiece covers 34, 36 for a telephone receiver 18. A drawstring 38 insures a snug fit to the receiver 18. The device of the present invention 10 is provided in various sizes and shapes to accommodate various type phones. The present invention 10 may be provided in various shapes and sizes including cell phones, cordless phones and public phones. Draw strings 38 are provided which are tied around the covers 34, 36 to insure a tight fit around the mouthpiece and earpiece of the telephone receiver 18.

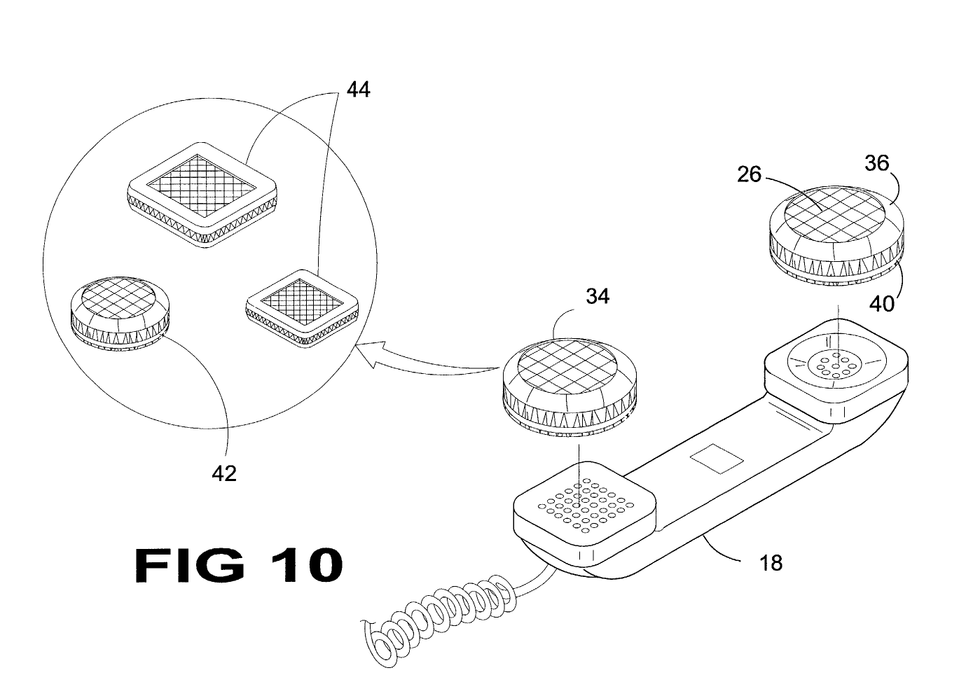

Turning to FIG. 10, shown therein is a pictorial illustration depicting individual mouth and earpiece covers 34, 36 for a telephone receiver. An elastic band 40 insures a snug fit to the receiver 18. Shown are a round shape 42 and a rectangular shape 44 in two sizes.

What is claimed to be new and desired to be protected by Letters Patent is set forth in the appended claims.

I claim:

1. An apparatus for a hygienic cover for a telephone receiver, comprising:
a) a hygienic cover, said cover for receiving a telephone receiver, said cover having a back side, said cover having a first end for receiving a first, rear piece end of said receiver and a second end for receiving a second, mouthpiece end of said receiver;
b) a first germicidal screen disposed on said first end of said cover;
c) a second germicidal screen disposed on said second end of said cover;
d) said cover being generally complementarily shaped as the telephone receiver; and,
e) said back side of said cover having an opening disposed therein, said opening for receiving the telephone receiver.

2. The apparatus of claim 1, wherein said cover is made of elastomeric material.

3. The apparatus of claim 2, wherein said cover is made of biodegradable material.

4. The apparatus of claim 3, wherein said cover is made of paper material.

5. The apparatus of claim 4, wherein said first germicidal screen is contiguous to said first, ear piece end of said receiver.

6. The apparatus of claim 5, wherein said second germicidal screen is contiguous to said second mouthpiece end of said receiver.

7. The apparatus of claim 6, wherein said opening is elliptically shaped.

8. The apparatus of claim 7, wherein said second end of said cover has a slit therein, said slit for receiving the telephone cord.

9. The apparatus of claim 8, wherein said slit extends from said elliptical opening to said second end of said cover.

10. An apparatus for a hygienic cover for a telephone receiver, comprising:
a) a first germicidal cover for disposition on a first, ear piece end of the telephone receiver; and,
b) a second germicidal cover for disposition on a second, mouth piece end of the telephone receiver.

11. The apparatus of claim 10, wherein said first germicidal cover and said second germicidal cover are each contiguous to said first, ear piece end and said second, mouthpiece end, respectively, of the telephone receiver.

12. The apparatus of claim 11, wherein said first and said second germicidal covers each further comprise draw strings for being secured to the telephone receiver.

13. The apparatus of claim 12, wherein said first and said second germicidal covers each further comprise elastic bands for being secured to the telephone receiver.

14. The apparatus of claim 13, wherein said first and said second germicidal covers are round in shape.

15. The apparatus of claim 14, wherein said first and said second germicidal covers are square in shape.
